(19) United States
(12) Patent Application Publication
(10) Pub. No.: US 2020/0292410 A1
(43) Pub. Date: Sep. 17, 2020

(54) METHOD AND SYSTEM FOR DETERMINING ROTOR STATES

(71) Applicant: Bell Textron Inc., Fort Worth, TX (US)

(72) Inventors: Charles Eric COVINGTON, Colleyville, TX (US); Michael David TRANTHAM, Arlington, TX (US); Evan Butler BENNETT, Fort Worth, TX (US)

(73) Assignee: Bell Textron Inc., Fort Worth, TX (US)

(21) Appl. No.: 16/678,009

(22) Filed: Nov. 8, 2019

Related U.S. Application Data
(60) Provisional application No. 62/816,382, filed on Mar. 11, 2019.

(51) Int. Cl. G01M 5/00; B64C 27/00; B64C 27/02; B64C 27/51

(52) U.S. Cl. CPC G01M 5/0016; B64C 27/51; B64C 27/028; B64C 27/008

(57) ABSTRACT

An example of a rotor-state determining method for a rotor system includes, by a flight control computer, collecting data from a first sensor positioned on a first component of the rotorcraft, wherein the first sensor is isolated from movement of a rotor blade, collecting data from a second sensor positioned on a second component of the rotor system, wherein the second sensor detects movement of the rotor blade, filtering the data collected by the first sensor to remove noise from the data collected by the first sensor, filtering the data collected by the second sensor to remove noise from the data collected by the second sensor, calculating a difference between the filtered first data and the filtered second data to determine a parameter of the rotor blade, and responsive to the motion of the rotor blade, taking a corrective action.

### CROSS-REFERENCE TO RELATED APPLICATIONS

This application claims the benefit of priority to and incorporates by reference the entire disclosure of U.S. Provisional Patent Application No. 62/816,382 filed on Mar. 11, 2019.

### BACKGROUND

This section provides background information to facilitate a better understanding of the various aspects of the disclosure. It should be understood that the statements in this section of this document are to be read in this light, and not as admissions of prior art.

Rotor aircraft, such as helicopters and tiltrotor aircraft, include one or more rotor systems. Each rotor system includes a mast driven by a power source (e.g., an engine or motor) and a yoke connected to the mast. A plurality of rotor blades are generally indirectly connected to the yoke with bearings. The bearings may be, for example, elastomeric bearings constructed from a rubber type material that absorb vibration. The bearings accommodate forces acting on the rotor blades allowing each rotor blade to flex with respect to the yoke/mast and other rotor blades. The weight of the rotor blades and the lift of the rotor blades generated by action of the rotor blades may result in transverse forces on the yoke and other components.

During operation of the rotor system, the rotor blades experience different rotor states. Rotor states include flapping, coning, axial, feathering, and lead-lag. Flapping can refer to an up-and-down movement of a rotor blade positioned at a right angle to the plane of rotation or can refer to a gimballing of the hub or a teetering rotor. Coning generally refers to an upward flexing of a rotor blade due to lift forces acting on the rotor blade. Axial forces generally refer to a centrifugal force on the rotor blades resulting from rotation of the rotor blades. Lead-lag forces generally refer to forces resulting from a horizontal movement of the rotor blades about a vertical pin that occur if, for example, the rotor blades do not rotate at the same rate as the yoke. Feathering forces generally refer to forces resulting from twisting motions that cause a rotor blade to change pitch.

In some applications, it is desirable to quantify the various rotor states during operation of the rotor aircraft. Conventionally, the determination of the various rotor states has been done via mechanical linkages and sensors. While using mechanical linkages has proven successful, adding mechanical linkages to the rotor system adds complexity and weight to the rotor system.

### SUMMARY

An example of a rotor-state determining system for a rotor system includes a hub attached to a mast, a rotor blade coupled to the hub, a first sensor positioned on a first component of the rotor system, wherein the first sensor is isolated from movement of the rotor blade, and a second sensor positioned on a second component of the rotor system, wherein the second sensor detects movement of the rotor blade.

An example of a rotor-state determining method for a rotorcraft includes, by a flight control computer, collecting data from a first sensor positioned on a first component of the rotorcraft, wherein the first sensor is isolated from movement of a rotor blade, collecting data from a second sensor positioned on a second component of the rotorcraft, wherein the second sensor detects movement of the rotor blade, filtering the data collected by the first sensor to remove noise from the data collected by the first sensor, filtering the data collected by the second sensor to remove noise from the data collected by the second sensor, calculating a difference between the filtered first data and the filtered second data to determine a parameter of the rotor blade, and responsive to a determination that the parameter of the rotor blade exceeds a threshold value, taking a corrective action.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 illustrates a rotorcraft in accordance with aspects of the disclosure;

FIGS. 2A and 2B illustrate prior art systems for determining blade flapping angle;

FIG. 3 is an illustrative schematic of a system for determining blade flapping angle according to aspects of the disclosure;

FIG. 4 is an illustrative schematic of a system for determining blade flapping angle according to aspects of the disclosure;

FIG. 5 is an illustrative process flow for determining flapping according to aspects of the disclosure;

FIG. 6 is an illustrative process flow for determining flapping according to aspects of the disclosure;

FIG. 7 is an illustrative schematic of a system for determining various rotor states according to aspects of the disclosure;

FIG. 8 is an illustrative schematic of a system for determining various rotor states according to aspects of the disclosure;

FIG. 9 is an illustrative schematic of a system for determining various rotor states according to aspects of the disclosure; and

FIG. 10 is a schematic diagram of a general-purpose processor (e.g. electronic controller or computer) system suitable for implementing aspects of the disclosure.

### DETAILED DESCRIPTION

It is to be understood that the following disclosure provides many different aspects, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

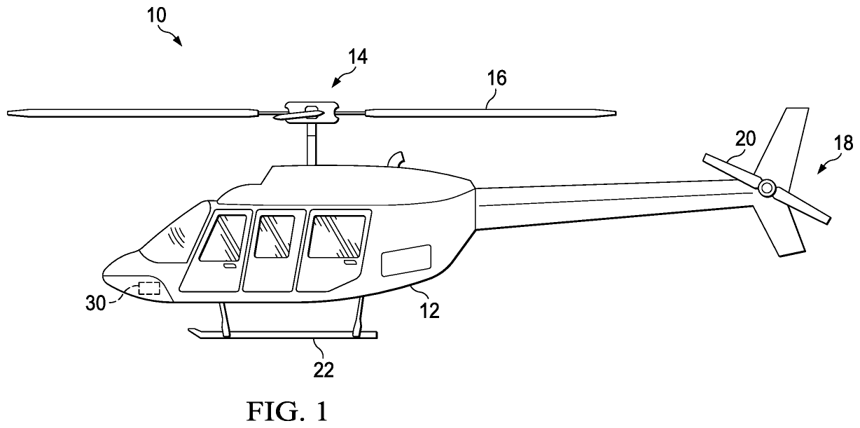

FIG. 1 illustrates an example of a rotorcraft 10. Rotorcraft 10 includes a fuselage 12, a main rotor system 14 with rotor blades 16, and a tail rotor system 18 with tail rotor blades 20. An engine within fuselage 12 supplies main rotor system 14 and tail rotor system 18 with torque to rotate rotor blades 16 and tail rotor blades 20. As illustrated in FIG. 1, rotorcraft 10 includes four rotor blades 16. In other aspects, rotorcraft 10 could include as few as one, two, or three rotor blades 16 or more than four rotor blades 16 (e.g., five, six, etc.). Landing gear 22 extend from fuselage 12 and support rotorcraft 10 when rotorcraft 10 is landing or when rotorcraft 10 is at rest on the ground. Rotorcraft 10 includes a flight control computer 30 configured monitor and control aspects of rotorcraft 10. Rotorcraft 10 is not meant to be limiting. Aspects of the disclosure apply to other rotorcraft as well.

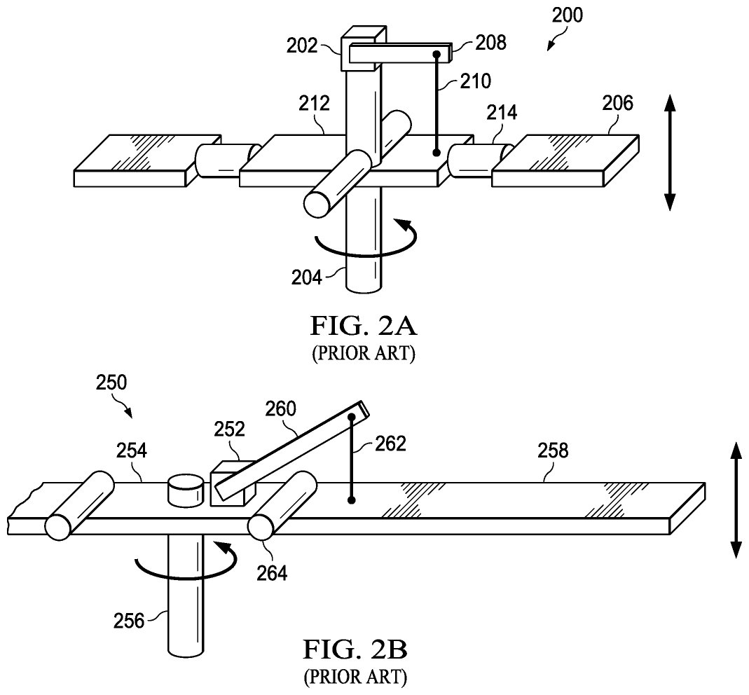

Referring now to FIGS. 2A-2B, prior art systems for determining blade flapping angle of a rotor blade are illustrated. FIG. 2A illustrates a system 200 for use with a teetering hub. System 200 includes a sensor 202 that is secured to a mast 204. Sensor 202 is coupled to a rotor blade 206 via an arm 208 and a linkage 210. Arm 208 is coupled to sensor 202 at one end and to a first end of linkage 210 at an opposite end. An opposite end of linkage 210 is coupled to a hub 212. Rotor blade 206 is connected to hub 212 in a manner that allows for a teetering motion of rotor blade 206 about hub 212 (out of plane motion, such as blade flapping). System 200 also includes a feathering hinge 214 that permits a longitudinal rotation (e.g., feathering) of rotor blade 206 relative to hub 212 Out of plane motion of rotor blade 206 displaces linkage 210, which causes arm 208 to rotate. The rotation of arm 208 is measured by sensor 202 to determine an amount of blade flapping.

FIG. 2B illustrates a system 250 for use with an offset hinge rotor. System 250 includes a sensor 252 that is secured to a hub 254 of the offset hinge rotor. Hub 254 is coupled to a mast 256. Sensor 252 is coupled to a rotor blade 258 via an arm 260 and a linkage 262. Arm 260 is coupled to sensor 252 at one end and to a first end of linkage 262 at an opposite end. An opposite end of linkage 262 is coupled to a rotor blade 258 outboard of a flapping hinge 264. Flapping hinge 264 allows rotor blade 258 to move out of plane to permit at least some amount of blade flapping. Out of plane motion of rotor blade 258 displaces linkage 262, which causes arm 260 to rotate. The rotation of arm 260 is measured by sensor 252 to determine an amount of blade flapping.

While systems 200 and 250 are capable of determining blade flapping angle, they require the use of several mechanical components (e.g., arms and linkages) that add complexity and weight to the rotor system. Reducing the weight and complexity of these systems would be beneficial.

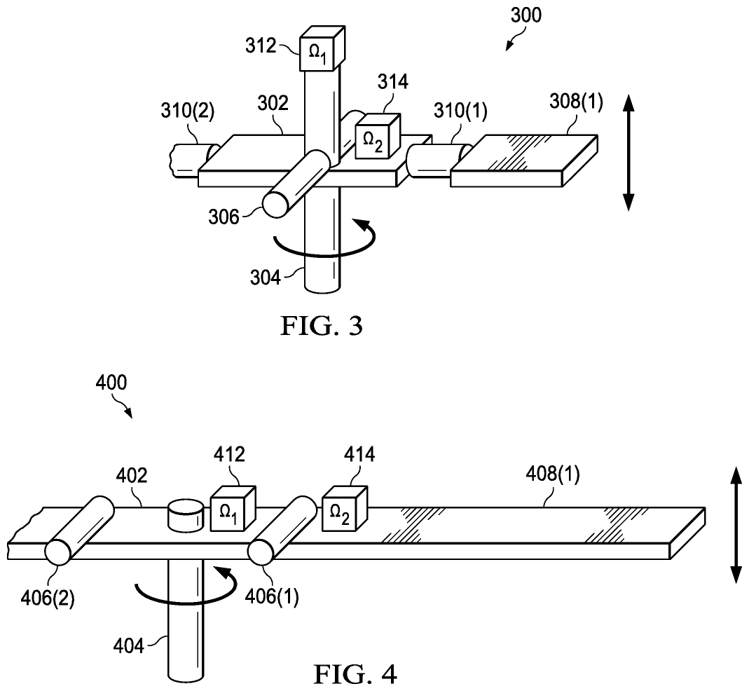

Referring now to FIG. 3, an illustrative schematic of a rotor system 300 is shown according to aspects of the disclosure. Rotor system 300 may incorporated into rotorcraft 10 or another aircraft. In other aspects, rotor system 300 may be incorporated into other machines that include rotors, such as a wind turbine and the like. Rotor system 300 is a teetering two-bladed rotor system and includes a teetering teetering hub 302 secured to a mast 304 about a flapping hinge 306. Rotor system 300 includes a pair of rotor blades 308(1), 308(2), each of which is secured to teetering hub 302 via feathering hinges 310(1), 310(2). Feathering hinges 310(1), 310(2) allow rotor blades 308(1), 308(2) to feather about a longitudinal axis of rotor blades 308(1), 308(2). Flapping hinge 306 allows rotor blades 308(1), 308(2) to pivot relative to mast 304. Only rotor blade 308(1) is illustrated in FIG. 3. It should be understood that rotor system 300 is generally symmetric and that rotor blade 308(2) is located opposite of rotor blade 308(1).

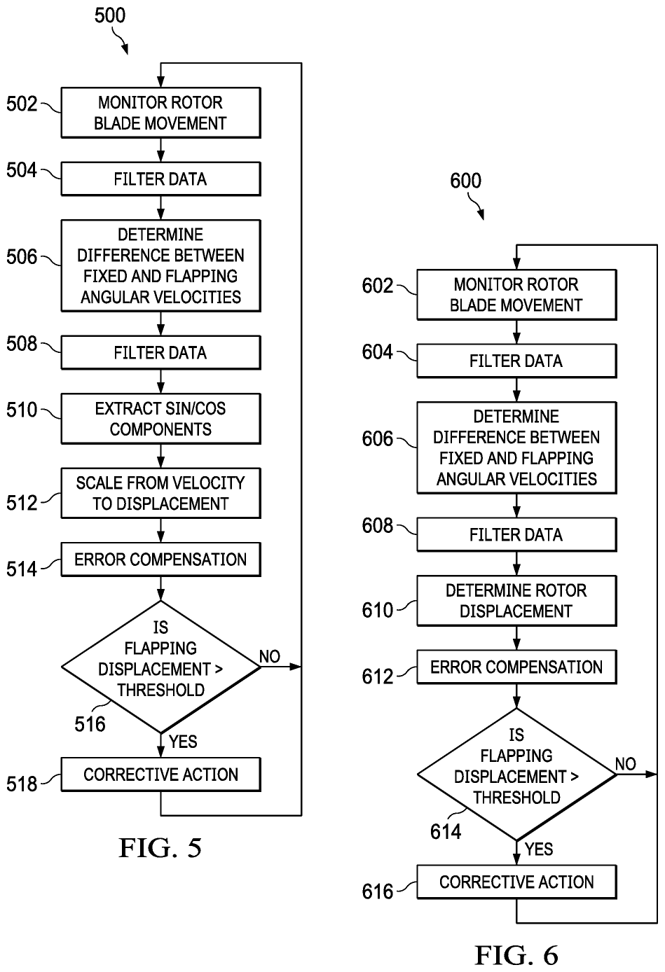

Rotor system 300 also includes a first sensor 312 positioned on mast 304 and a second sensor 314 positioned on teetering hub 302. First sensor 312 is an inertial sensor, such as an angular rate sensor, that senses out-of-plane angular velocity of the non-flapping portion of rotor system 300. Inertial sensors measure motions relative to an inertial reference frame as opposed to sensors which measure motion relative to another body (e.g., sensor 202). Because first sensor 312 is isolated from teetering hub 302, first sensor 312 only detects rigid body and elastic motions of rotorcraft 10. In some embodiments, first sensor 312 could be located somewhere else on fuselage 12 or another part of the aircraft that is isolated from the motion of teetering hub 302. Second sensor 314 is an inertial sensor, such as an angular rate sensor, that senses out-of-plane angular velocity of teetering hub 302 to detect flapping motions of rotor blade 308(1). Teetering hub 302 is coupled to mast 304, which is coupled to the airframe of rotorcraft 10. As a result, second sensor 314 also detects the rigid body and elastic motions of rotorcraft 10, in addition to the flapping motions of rotor blade 308(1). The difference in the angular velocity measured by sensors 312, 314 provides the instantaneous relative velocity of teetering hub 302, which can be used to estimate the flapping displacement of rotor blade 308(1) using a variety of techniques that are discussed in more detail relative to FIGS. 5 and 6 below. This concept can be extended to measure other rotor states (e.g., lead-lag, feathering, coning) and to other rotor system configurations (e.g., fully articulated or flexured rotors).

Referring now to FIG. 4, an illustrative schematic of a rotor system 400 is shown. Rotor system 400 illustrates an offset-hinge rotor and includes a hub 402 and a first sensor 412 secured to a mast 404. Rotor system 400 also includes a pair of rotor blades 408(1), 408(2), each of which is secured to hub 402 via flapping hinges 406(1), 406(2), respectively. Flapping hinges 406(1), 406(2) allow rotor blades 408(1), 408(2) to pivot relative to mast 404 to allow flapping. Only rotor blade 408(1) is illustrated in FIG. 4. It should be understood that rotor system 400 is generally symmetric and that rotor blade 408(2) is located opposite of rotor blade 408(1).

Rotor system 400 includes first sensor 412 that is positioned on hub 402 and a second sensor 414 that is positioned outboard of flapping hinge 406(1). First sensor 412 is an inertial sensor, such as angular rate sensor that senses out-of-plane angular velocity of a non-flapping portion of hub 402. First sensor 412 detects rigid body and elastic motions of the aircraft. Second sensor 414 is an inertial sensor that senses out-of-plane angular velocity of the portion of hub 402 and/or rotor blade 408(1) outboard of flapping hinge 406(1). Second sensor 414 detects flapping motions and rigid body and elastic motions of the aircraft. The difference in the angular velocity between sensors 412, 414 is the angular velocity of the flapping motion, which can be used to estimate flapping displacement using a variety of techniques that are discussed in more detail relative to FIGS. 5 and 6 below. Off-axis motions are a source of error, though the errors are small if the motions are small. The amount of off-axis motion depends on hub configuration (e.g., gimballed, teetering, flexured, bearingless) and location of the sensors relative to real or virtual hinges.

FIG. 5 is an illustrative method 500 for determining flapping using the rotor domain. FIG. 5 is discussed relative to FIG. 4 above. Those of skill in the art will recognize that aspects of method 500 may be applied to other rotor systems as well. In a typical aspect, flight control computer 30 carries out method 500. In other aspects, a separate computer module may carry out method 500. The separate computer module may be coupled to flight control computer 30. Method 500 begins with step 502. In step 502, movement of rotor blade 408(1) is monitored. Monitoring movement of rotor blade 408(1) includes collecting angular-rate data from sensors 412, 414. Method 500 then proceeds to step 504.

In step 504, the data from one or both of sensors 412, 414 is filtered. For example, out-of-band content is removed from the data to improve a signal to noise ratio (SNR) of the data. For example, step 504 can include filtering data received from first sensor 412 to remove high-frequency and low-frequency noise from data output by first sensor 412. Data from second sensor 414 may be similarly filtered in step 504. Method 500 then proceeds to step 506.

At step 506, a difference between the fixed and flapping angular velocities is determined to reject rigid body and elastic motions of mast 404. For example, flight control computer 30 may determine the difference by subtracting the magnitude of the data of first sensor 412 from the magnitude of the data of second sensor 414. The difference between the two data sets describes a parameter of the rotor blade, which in this example is an amount of flapping of rotor blade 408(1). In other aspects, the parameter may describe coning, feathering, lead/lag, or the like. In some aspects, method 500 proceeds to step 508 in which the data from step 506 may be filtered to further improve the SNR. In some aspects, step 508 is optional. Method 500 then proceeds to step 510.

At step 510, the 1/revolution sine and cosine components of the difference signals are extracted from the output of step 508, which can be done using known techniques. An azimuth of mast 404 is used to provide a phase reference for demodulation of motion into its sine and cosine components and for RPM measurement. In some aspects, the value of the azimuth of mast 404 is a property known by flight control computer 30. The extracted sine/cosine components of step 510 are used in step 512 to scale from velocity to displacement (e.g., via integration). In some aspects, bandwidth is low enough to assume quasi-sinusoidal steady state. At step 514, non-ideal effects incurred due to filtering and delays can be directly accounted for using various known techniques. Step 514 outputs a determined flapping displacement. Method 500 then proceeds to step 516.

At step 516, flight control computer 30 compares the determined flapping displacement to a threshold value of flapping displacement. The threshold value of flapping displacement is a maximum amount of flapping that is desirable. Exceeding the maximum amount of flapping can lead to damage, loss of control, or other failures. If the value of the determined flapping displacement is less than the threshold value, rotorcraft 10 continues operation and method 500 returns to step 502. If the value of the determined flapping displacement is greater than the threshold value of flapping displacement, method 500 proceeds to step 518 and flight control computer 30 takes a corrective action. The corrective action can be an automatic change to an operating parameter of rotorcraft 10 (e.g., change pitch of the rotor blades, change amount or direction of cyclic, change amount of collective, change rpm of the rotor blades, etc.) and/or an alert or alarm that is presented to a pilot (e.g., a flashing light, an audible warning, a vibrating seat, and the like).

FIG. 6 is an illustrative method 600 for determining flapping using the time domain. FIG. 6 will be discussed relative to FIG. 4 above. In a typical aspect, flight control computer 30 carries out method 600. In other aspects, a separate computer module may carry out method 600. The separate computer module may be coupled to flight control computer 30. Steps 602, 604, 606, and 608 are similar to steps 502, 504, 506, and 508 discussed above relative to FIG. 5. At step 610, flight control computer 30 determines an integral of the resulting flapping velocity signal of step 608 to produce displacement signals. For example, a lossy integration technique can be used. The integrator is configured to remove any steady-state or offset errors that build over time due to non-idealities in the source data or signal conditioning. Steps 612-616 are similar to steps 514-518 discussed above relative to FIG. 5.

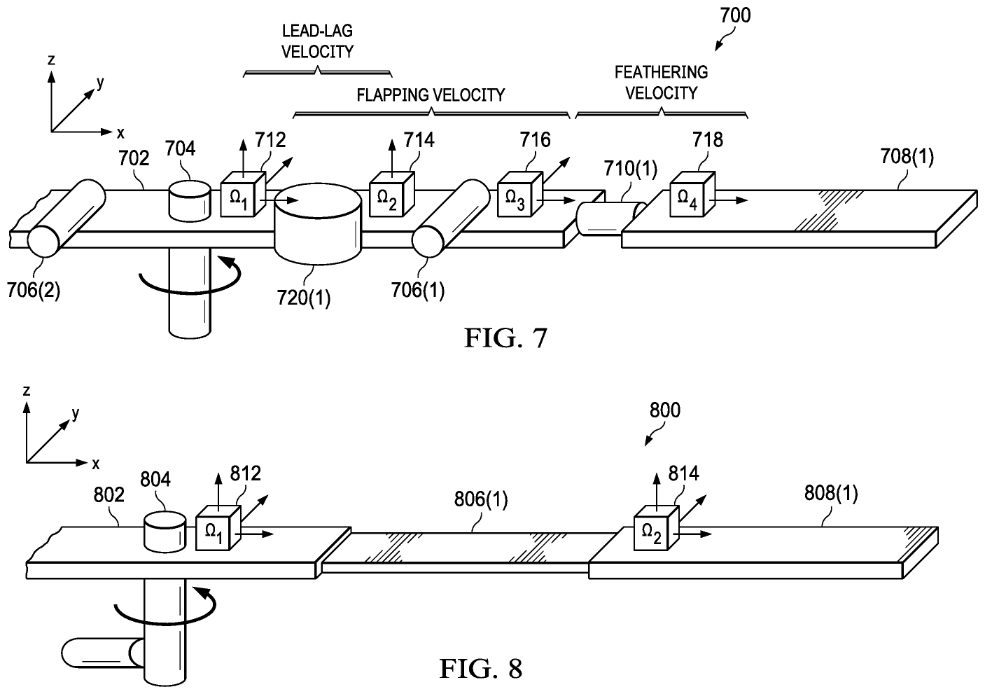

Referring now to FIG. 7, an illustrative schematic of a rotor system 700 is shown. Rotor system 700 illustrates a discrete hinge example and includes a hub 702 secured to a mast 704. Rotor system 700 also includes a pair of rotor blades 708(1), 708(2) secured to hub 702. Rotor blades 708(1), 708(2) are secured to hub 702 via flapping hinges 706(1), 706(2), feathering hinges 710(1), 710(2), and lead-lag hinges 720(1), 720(2), respectively. In some aspects, hinges 706, 710, and 720 may be connected in series as a part of an armature or linkage that is disposed between hub 702 and rotor blade 708. Only rotor blade 708(1) is illustrated in FIG. 7. It should be understood that rotor system 700 is generally symmetric and that rotor blade 708(2) is located opposite of rotor blade 708(1).

Rotor system 700 also includes a first sensor 712 that is positioned on hub 702, a second sensor 714 that is positioned between lead-lag hinge 720(1) and flapping hinge 706(1), a third sensor 716 positioned between flapping hinge 706(1) and feathering hinge 710(1), and a fourth sensor 718 positioned between feathering hinge 710(1) and rotor blade 708(1). Each of sensors 712-718 are inertial sensors that measure motions relative to inertial reference frames as illustrated by arrows in FIG. 7.

Including sensors 712-718 allows for lead-lag, coning, flapping, and feathering rotor states to be monitored. Lead-lag motion can be estimated from an angular velocity difference in local Z-axis rotation sensed by first sensor 712 and second sensor 714. Coning can be measured as a quasi-steady angular velocity difference in local Z-axis rotation sensed by first sensor 712 and third sensor 716. The difference in sensed rotational velocity varies with the cosine of the coning angle. Flapping motion appears as oscillatory content and is the second harmonic of actual flapping motion and also appears in the difference in sensed angular velocity as the first harmonic of rotor angular motion. Oscillatory feathering motion can be estimated from the difference in local X-axis rotation between third sensor 716 and fourth sensor 718. The Z and Y axes of fourth sensor 718 contain flapping, coning, and lead-lag motion information. However, these measurements may have components of other motions in them due to off-axis effects. One of skill in the art will recognize that the concepts of methods 500 and 600 may be used in combination with rotor system 700 to determine various aspects of the rotor states thereof (e.g., lead-lag, coning, flapping, and feathering rotor states).

Referring now to FIG. 8, an illustrative schematic of a rotor system 800 is shown. Rotor system 800 illustrates a hingeless/bearingless rotor system and includes a hub 802 secured to a mast 804. Rotor system 800 includes a pair of rotor blades 808(1), 808(2) that are coupled to hub 802 via flexures 806(1), 806(2), respectively. Only rotor blade 808(1) is illustrated in FIG. 8. It should be understood that rotor system 800 is generally symmetric and that rotor blade 808(2) is located opposite of rotor blade 808(1).

Rotor system 800 also includes a first sensor 812 that is positioned on hub 802 and a second sensor 814 that is positioned outboard of flexure 806(1). Each of sensors 812, 814 are inertial sensors, such as multi-axis angular rate sensors. Including sensors 812-814 allows for lead-lag, coning, flapping, and feathering rotor states to be monitored. Flapping and coning angle motion can be determined based upon an angle between the rotation vector indicated by first sensor 812 and the rotation vector indicted by a second sensor 814, projected onto the rotating XZ plane. Lead-lag angular motion can be determined based upon the difference in magnitude of rotation vectors indicated by first sensor 812 and second sensor 814. It is noted that flapping, feathering, and coning change a direction of the rotation vector sensed by second sensor 814, but not the magnitude of an output of second sensor 814. Feathering angle can be determined based upon a projection onto the rotating YZ plane of an angle between a rotation vector provided by first sensor 812 and second sensor 814. Rotor speed can be determined based upon rotation indicated by first sensor 812 about the Z axis. One of skill in the art will recognize that the concepts of methods 500 and 600 may be used in combination with rotor system 800 to determine various aspects of the rotor states thereof (e.g., lead-lag, coning, flapping, and feathering rotor states).

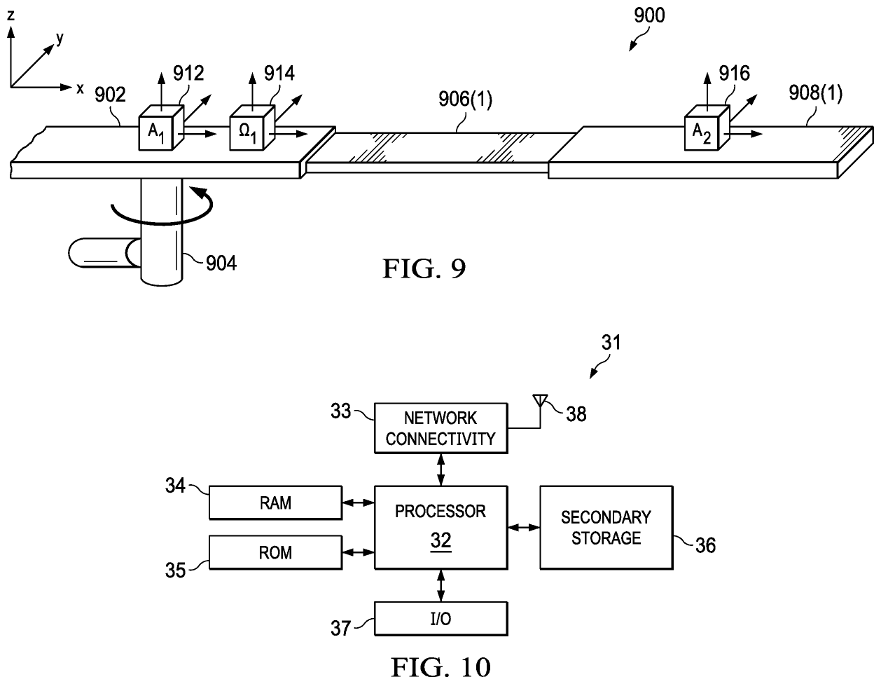

Referring now to FIG. 9, an illustrative schematic of a rotor system 900 is shown. Rotor system 900 illustrates a hingeless/bearingless rotor system and includes a hub 902 secured to a mast 904. Rotor system 900 includes a pair of rotor blades 908(1), 908(2) that are coupled to hub 902 via flexures 906(1), 906(2), respectively. Only rotor blade 908(1) is illustrated in FIG. 9. It should be understood that rotor system 900 is generally symmetric and that rotor blade 908(2) is located opposite of rotor blade 908(1).

Rotor system 900 also includes a first sensor 912 that is positioned on hub 902 and coaxial with mast 904, a second sensor 914 that is positioned on hub 902 but outboard of a centerline of mast 904, and a third sensor 916 that is positioned on rotor blade 908(1). First sensor 912 and third sensor 916 are three-axis accelerometers and second sensor 914 is an angular rate sensor. Including sensors 912-916, each of which may be an inertial sensor, allows for lead-lag, coning, and flapping rotor states to be monitored. Flapping and coning angular motion can be determined based upon an out-of-plane (of rotor rotation) projection of an angle between a centrifugal force (CF) vector computed by second sensor 914 (about the Z axis; corrected by first sensor 912) and a CF vector indicted by third sensor 916. Lead-lag angle can be determined by an in-plane (of rotor rotation) projection of an angle between a CF vector computed by second sensor 914 (about the Z axis; corrected by first sensor 912) and a CF vector indicted by third sensor 916. RPM can be determined based upon second sensor 914 about the Z axis. One of skill in the art will recognize that the concepts of methods 500 and 600 may be used in combination with rotor system 900 to determine various aspects of the rotor states thereof (e.g., lead-lag, coning, and flapping rotor states).

Referring now to FIG. 10, a schematic diagram of a general-purpose processor (e.g. electronic controller or computer) system 31 suitable for implementing the aspects of this disclosure is shown. System 31 includes processing component and/or processor 32 suitable for implementing one or more aspects disclosed herein. In some aspects, flight control computer 30 and/or other electronic systems of rotorcraft 10 may include one or more systems 31. In addition to processor 32 (which may be referred to as a central processor unit or CPU), system 31 might include network connectivity devices 33, random access memory (RAM) 34, read only memory (ROM) 35, secondary storage 36, and input/output (I/O) devices 37. In some cases, some of these components may not be present or may be combined in various combinations with one another or with other components not shown. These components might be located in a single physical entity or in more than one physical entity. Any actions described herein as being taken by the processor 32 might be taken by the processor 32 alone or by the processor 32 in conjunction with one or more components shown or not shown in the system 31. It will be appreciated that the data described herein can be stored in memory and/or in one or more databases.

Processor 32 executes instructions, codes, computer programs, or scripts that it might access from the network connectivity devices 33, RAM 34, ROM 35, or secondary storage 36 (which might include various disk-based systems such as hard disk, floppy disk, optical disk, or other drive). While only one processor 32 is shown, multiple processors 32 may be present. Thus, while instructions may be discussed as being executed by processor 32, the instructions may be executed simultaneously, serially, or otherwise by one or multiple processors 32. The processor 32 may be implemented as one or more CPU chips and/or application specific integrated chips (ASIC s).

The network connectivity devices 33 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 33 may enable the processor 32 to communicate with the Internet or one or more telecommunications networks or other networks from which the processor 32 might receive information or to which the processor 32 might output information.

The network connectivity devices 33 might also include one or more transceiver components 38 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 38 might include separate receiving and transmitting units or a single transceiver. Information transmitted or received by the transceiver component 38 may include data that has been processed by the processor 32 or instructions that are to be executed by processor 32. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

RAM 34 might be used to store volatile data and perhaps to store instructions that are executed by the processor 32. The ROM 35 is a non-volatile memory device that typically has a smaller memory capacity than the memory capacity of the secondary storage 36. ROM 35 might be used to store instructions and perhaps data that are read during execution of the instructions. Access to both RAM 34 and ROM 35 is typically faster than to secondary storage 36. The secondary storage 36 is typically comprised of one or more disk drives or tape drives and might be used for non-volatile storage of data or as an over-flow data storage device if RAM 34 is not large enough to hold all working data. Secondary storage 36 may be used to store programs or instructions that are loaded into RAM 34 when such programs are selected for execution or information is needed.

The I/O devices 37 may include liquid crystal displays (LCDs), touchscreen displays, keyboards, keypads, switches, dials, mice, track balls, voice recognizers, card readers, paper tape readers, printers, video monitors, transducers, sensors, or other well-known input or output devices. Also, transceiver component 38 might be considered to be a component of the I/O devices 360 instead of or in addition to being a component of the network connectivity devices 33. Some or all of the I/O devices 37 may be substantially similar to various components disclosed herein and/or may be components of a flight control system and/or other electronic systems of rotorcraft 10.

The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” “generally,” and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. For example, the various rotor systems described herein may be incorporated into various devices/machines that include rotors such as wind turbines and the like. Those skilled in the art should also realize that such equivalent constructions do not depart from the spirit and scope of the disclosure, and that they may make various changes, substitutions and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. A rotor-state determining system for a rotor system, the rotor-state determining system comprising:
a hub attached to a mast;
a rotor blade coupled to the hub;
a first sensor positioned on a first component of the rotor system, wherein the first sensor is isolated from movement of the rotor blade; and
a second sensor positioned on a second component of the rotor system, wherein the second sensor detects movement of the rotor blade.

2. The rotor-state determining system of claim 1, comprising:
wherein the first component is the mast; and
wherein the second component is a root end of the rotor blade.

3. The rotor-state determining system of claim 1, comprising:
wherein the first component is a non-rotating component of the rotor system.

4. The rotor-state determining system of claim 1, comprising:
a flapping hinge positioned between the rotor blade and the hub;
wherein the first component is the hub; and
wherein the second sensor is located outboard of the flapping hinge.

5. The rotor-state determining system of claim 1, comprising:
a flexure positioned between the rotor blade and the hub;
wherein the first component is the hub; and
wherein the second component is the rotor blade.

6. The rotor-state determining system of claim 5, wherein the second sensor is an accelerometer.

7. The rotor-state determining system of claim 5, wherein the second sensor is an angular rate sensor.

8. The rotor-state determining system of claim 5, comprising:
a third sensor disposed on the mast;
wherein the first sensor is an angular rate sensor;
wherein the first component is the hub; and
wherein the second and third sensors are accelerometers.

9. The rotor-state determining system of claim 1, comprising:
a lead-lag hinge, a flapping hinge, and a feathering hinge positioned between the hub and the rotor blade;
a third sensor disposed outboard of the flapping hinge;
a fourth sensor disposed on the rotor blade;
wherein the first component is the hub; and
wherein the second component is outboard of the hub and inboard of the flapping hinge.

10. A rotor-state determining method for a rotorcraft, the method comprising by a flight control computer:
collecting data from a first sensor positioned on a first component of the rotorcraft, wherein the first sensor is isolated from movement of a rotor blade;
collecting data from a second sensor positioned on a second component of the rotorcraft, wherein the second sensor detects movement of the rotor blade;
filtering the data collected by the first sensor to remove noise from the data collected by the first sensor;
filtering the data collected by the second sensor to remove noise from the data collected by the second sensor;
calculating a difference between the filtered first data and the filtered second data to determine a parameter of the rotor blade; and
taking a corrective action responsive to the parameter of the rotor blade.

11. The rotor-state determining method of claim 10, wherein the corrective action comprises at least one of changing a pitch of the rotor blade, changing an amount or direction of cyclic, changing an amount of collective, and changing an rpm of the rotor blade.

12. The rotor-state determining method of claim 10, wherein the corrective action comprises an alert.

13. The rotor-state determining method of claim 10, comprising:
wherein the first component is a mast of the rotorcraft; and
wherein the second component is the rotor blade.

14. The rotor-state determining method of claim 10, wherein the second sensor is located outboard of a flapping hinge.

15. The rotor-state determining method of claim 10, comprising:
a flapping hinge positioned between the rotor blade and a hub;
wherein the first component is the hub; and
wherein the second sensor is located outboard of the flapping hinge.

16. The rotor-state determining method of claim 10, comprising:
a flexure positioned between the rotor blade and a hub;
wherein the first component is the hub; and
wherein the second component is the rotor blade.

17. The rotor-state determining method of claim 10, wherein the parameter of the rotor blade is selected from the group consisting of a flapping parameter, a coning parameter, a feathering parameter, and a lead/lag parameter.

18. The rotor-state determining method of claim 17, comprising:
a lead-lag hinge, a flapping hinge, and a feathering hinge positioned between a hub and the rotor blade;
a third sensor disposed outboard of the flapping hinge;
a fourth sensor disposed on the rotor blade;
wherein the first component is the hub; and
wherein the second component is outboard of the hub and inboard of the flapping hinge.

19. The rotor-state determining method of claim 18, wherein the parameter of the rotor blade is selected from the group consisting of a flapping parameter, a coning parameter, a feathering parameter, and a lead/lag parameter.

20. An aircraft comprising a rotor-state determining system, the aircraft comprising:
a fuselage; and
a rotor system secured to the fuselage and comprising:
a hub attached to a mast;
a rotor blade coupled to the hub;
a first sensor positioned on a first component of the rotor system, wherein the first sensor is isolated from movement of the rotor blade; and
a second sensor positioned on a second component of the rotor system, wherein the second sensor detects out of plane movement of the rotor blade.
